(19) United States
(12) Patent Application Publication
(10) Pub. No.: US 2002/0091579 A1
(43) Pub. Date: Jul. 11, 2002

(54) Method and system for managing and correlating orders in a multilateral environment

(75) Inventors: Ramzi Yehia, Coral Springs, FL (US); John Yin, Boca Raton, FL (US); Oleg Mikulinsky, Boca Raton, FL (US)

Correspondence Address: FLEIT, KAIN, GIBBONS,, GUTMAN & BONGINI, P.L., ONE BOCA COMMERCE CENTER, 551 NORTHWEST 77TH STREET, SUITE 111, BOCA RATON, FL, 33487, US

(73) Assignee: PartnerCommunity, Inc.

(21) Appl. No.: 09/757,227

(22) Filed: Jan. 9, 2001

(51) Int. Cl. G06F 17/60

(52) U.S. Cl. 705/26

(57) ABSTRACT

A method and system for managing and correlating orders in a multilateral environment. The multilateral environment includes two or more trading partners trading goods and services. The system is based on a hub and spoke architecture. The hub presents to each of the partners using a partner system a user interface for receiving an order. The order when received is parsed into tags. Each tag represents a predefined field in an order such as price, quantity, delivery date and other contractual terms. These tags are placed into a database schema using a naming structure that is identical to the naming structure used for the tag values so that elements in the database schema can be populated directly from the tag values. Each partner in the value chain, which supplies a good and service for the order, forms one or more hierarchical contractual relationships. Contract tag values are retrieved for each trading partner in the hierarchical contractual relationship. The contract tag values are analyzed for compliance with the tag values for the order. The order is then sent to each of the trading partners in the value chain if the order complies with the contract tag values.

### PARTIAL WAIVER OF COPYRIGHT

All of the material in this patent application is subject to copyright protection under the copyright laws of the United States and of other countries. As of the first effective filing date of the present application, this material is protected as unpublished material. However, permission to copy this material is hereby granted to the extent that the copyright owner has no objection to the facsimile reproduction by anyone of the patent documentation or patent disclosure, as it appears in the United States Patent and Trademark Office patent file or records, but otherwise reserves all copyright rights whatsoever.

### CROSS REFERENCE TO RELATED APPLICATIONS

Not Applicable

### BACKGROUND OF THE INVENTION

1. Field of the Invention

This invention generally relates to the field of management system for contracts and more particularly to the field managing and correlation orders and contracts in a mutlilateral environment.

2. Description of the Related Art

The Internet and World-Wide-Web has created unprecedented growth in communications. On the Internet, B2B (business-to-business), also known as e-biz, is the exchange of products, services, or information between businesses rather than between businesses and consumers. Although early interest centered on the growth of retailing on the Internet (sometimes called e-tailing), forecasts are that B2B revenue will far exceed business-to-consumers (B2C) revenue in the near future. According to studies published in early 2000, the money volume of B2B exceeds that of e-tailing by 10 to 1. Over the next five years, B2B is expected to have a compound annual growth of 41%. The Gartner Group estimates B2B revenue worldwide to be $7.29 trillion dollars by 2004. In early 2000, the volume of investment in B2B by venture capitalists was reported to be accelerating sharply although profitable B2B sites were not yet easy to find.

B2B Web sites can be sorted into several categories:

Company Web sites, where the target audience for many company Web sites is other companies and their employees Company sites can be thought of as round-the-clock mini-trade exhibits. Sometimes a company Web site serves as the entrance to an exclusive extranet available only to customers or registered site users. Some company Web sites sell directly from the site, effectively e-tailing to other businesses.

Specialized or vertical industry portals which provide a “subWeb” of information, product listings, discussion groups, and other features. These vertical portal sites have a broader purpose than the procurement sites (although they may also support buying and selling).

Information sites (sometimes known as infomediary), which provide information about a particular industry for its companies and their employees. These include specialized search sites and trade and industry standards organization sites.

Brokering sites that act as an intermediary between someone wanting a product or service and potential providers. Equipment leasing is an example.

Product supply and procurement exchanges, where a company purchasing agent can shop for supplies from vendors, request proposals, and, in some cases, bid to make a purchase at a desired price. Sometimes referred to as e-procurement sites, some serve a range of industries and others focus on a niche market.

Many B2B sites may seem to fall into more than one of the categories above. Models for B2B sites are still evolving. (For more information on B2B refer to online URL www.whatis.com).

As participants in the B2B sites, providers of goods and services in the e-procurement and brokering sites strive to differentiate themselves from one another. These providers strive to build the best-of-breed set of services. One method these providers provide services is through the aggregation of services from one or more other providers. Providers understand that the basic venue for providing superior services lies in partnership. Many times these providers establish multilateral, complex partnering relations. Multilateral activities include many providers cooperating to provide a service or product to a customer. However, partnering arrangements are leading to new and unforeseen circumstances where service providers have a multitude of contracts with different partners.

One example of a multilateral relationship is as follows. The provider A is negotiating a contract with provider B to supply a service that A has purchased from provider C. Stated differently, A is reselling a service purchased from C to B. As a case in point, A may be reselling Internet bandwidth that has purchased from C. Often times, it is a requirement for provider A to be alerted during the negotiation that fulfillment of the new contract requires either, renegotiate the contract with partner C or decrease the commitment to partner B. This notification requirement could be due to the capacity that A is purchasing from C or due to other contracts that A committed to with other partners. On another hand, the notification requirement may be advantageous to partner C to design a contract with partner A based on the contracts of A with B. The managing of contract and notifications can be problematic, especially in multilateral relationships. Accordingly, a need exist for a method and system to manage the notifications for orders and contracts in a multilateral environment.

These multilateral relationships require coordination of contracts that are interdependent, complementary, and chained nature leading, to complex and intractable situation. In this environment contracts with other providers act as virtual inventory so, it is very critical to track orders against contracts and be able to initiate multilateral actions based on events relevant to contract terms. Accordingly, a need exists for an integrated order management, contract management and inventory system that has the visibility to the multilateral relations between partners.

One available system for contract management is ConTrack™ from Indigo Solutions™ and for order management is TBS from Metaslov. When a party to a multilateral contract detects a violation in a contract, the party typically turns one of these systems to review contract information. These currently available contract and order management systems although useful are not without their shortcomings. One shortcoming is that the currently available systems are stand-alone. The term stand-alone as used here means that these systems are installed at a given party's location without connection to the other party. The lack of connectivity prevents these stand-alone systems from initiating, coordinating and synchronizing actions/alerts in the mutlilateral environment. At the best, current contract management systems alert a user about critical dates of a contract but cannot associate and initiate actions that affect all parties related under the contract.

Another shortcoming with the current stand-alone order management systems are the inability to track contracts versus the orders, the status, the backorders, the fulfillment and many times the inventory. Accordingly, a need exists to provide a method and system to over come the shortcomings of these stand-alone contract and order management systems and to provide a system that can work with multiple contracting partners and parties.

Still, another shortcoming with existing stand-alone contract and order management systems is illustrated by an example in the telecommunication industry of prepaid service such as prepaid calling cards or prepaid cellular time. These prepaid systems can be thought of as a contract for the delivery of telephone service for a given price under certain terms and conditions. Typically the customers of these prepaid systems want to monitor the usage of their prepaid plan. Some of today's telecommunications systems notify the customer when the amount of usage approaches the prepaid amount and will cut off the service when the prepaid amount is completely used. However, these currently available contract and order management systems are tailored towards customer-to-business relations and they serve very specific functions. They also, do not provide a mechanism to notify other parties or partners of usage. For example, in the prepaid case, the service provider is not alerted to the fact that the customer used all of his prepaid credit. By not knowing the expiration of the prepaid credit, the service provider lost the chance to solicit further business from the customer. Accordingly, a need exists for a method and system to over come the shortcomings described here as well.

Still, another concern in multilateral contract management is the requirement to negotiate each of the contract terms with each of the parties in a multilateral environment. It is not uncommon for provider's contracts to be ten, twenty or even fifty pages in length. The requirement for each partner in the supply chain to negotiate with another partner in the supply chain is tedious and often requires significant legal expense. In addition, today's contract processes are manual and therefore expensive. The slow and tedious process of contract negotiations typically increases as the number of parties in the supply chain increases. Providers in the supply chain require quick time to market including the ability to replace existing services, and add new ones, on demand and in cases of service failures. Current contract systems do not offer solution for the multilateral environment of today's B2B transactions. Accordingly, a need exists for a system and method to overcome the above concerns and shortcomings and to provide automatic negotiation of contracts in a mutlilateral environment.

Yet, still another problem with current methods of contract negotiation that are manual is the susceptibility to human error. Today most contract negotiations depend on the negotiating individuals and their ability to capture and remember all existing contracts. This process is error prone, especially when considering the dynamics of current organizations and the potential of negotiating contracts by different individuals at different times and belonging to different departments and with different intentions. Currently available systems that provide contract management concentrate on managing individual contracts. That is, the current available systems monitor critical dates of those contracts, they categorize contracts and the group of contracts into active and non active ones. Although these features are useful, the currently available systems have an inherent problem when deployed in a multilateral environment. The currently available systems do not track dependencies between contracts of different partners and do not provide visibility to the chained nature of contracts. For example, it is common for contracts to have a performance clause that guarantees performance of the contracting parties. The tracking to avoid conflicts between performance clauses in multilateral relationships is problematic. Accordingly, a need exists for a system and method to overcome the above concerns and shortcomings and to provide automatic negotiation of contracts in a mutlilateral environment.

### SUMMARY OF THE INVENTION

Briefly, according to the present invention, disclosed is a method and system for managing and correlating orders and contracts in a multilateral environment. The multilateral environment includes two or more trading partners trading goods and services. The system is based on a hub and spoke architecture. The hub presents to each of the partners using a partner system an interface for receiving an order. The order when received is parsed into tags. Each tag represents a predefined field in an order such as price, quantity, delivery date and other contractual terms. These tags are placed into a database schema using a naming structure that is identical to the naming structure used for the tag values so that elements in the database schema can be populated directly from the tag values. Each partner in the value chain, which supplies a good and service for the order, forms one or more hierarchical contractual relationships. Contract tag values are retrieved for each trading partner in the hierarchical contractual relationship. The contract tag values are analyzed for compliance with the tag values for the order. The order is then sent to each of the trading partners in the value chain if the order complies with the contract tag values.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention will be apparent from the following detailed description taken in conjunction with the accompanying drawings.

FIG. 1 is a high-level system view of the hub and spoke architecture according to the present invention.

FIG. 2 is a block diagram illustrating the overall data flow for tag values between partners, according to the present invention.

FIG. 3 is a functional block diagram of the major system components using the hub and spoke architecture of FIG. 1, according to the present invention.

FIG. 4 is flow diagram of the order reconciliation according to the present invention.

FIG. 5 is a schema of an order entity relationship detailing the relationship between entities, according to the present invention.

FIGS. 6A and 6B are a template of the XML order tags used along with the order entity schema of FIG. 5, according to the present invention.

FIG. 7 is a tree diagram of the XML order tags in FIG. 6, according to the present invention.

FIG. 8 is flow diagram of the contract reconciliation according to the present invention.

FIG. 9 is a schema of a contract entity relationship schema detailing the relationship between contract components, according to the present invention.

FIGS. 10A and 10B are a template of the XML contract tags used along with the contract entity schema of FIG. 9, according to the present invention.

FIG. 11 is a tree diagram of the XML contract tags in FIG. 10, according to the present invention.

### DETAILED DESCRIPTION OF AN EMBODIMENT

It is important to note, that these embodiments are only examples of the many advantageous uses of the innovative teachings herein. In general, statements made in the specification of the present application do not necessarily limit any of the various claimed inventions. Moreover, some statements may apply to some inventive features but not to others In general, unless otherwise indicated, singular elements may be in the plural and visa versa with no loss of generality.

Glossary of Terms used in This Disclosure

Good—is any fungible or non-fungible item that is exchanged between partners with or without the exchange of any valuable consideration such as money or credit.

Hierarchical relationship or hierarchical contractual relationship—is a contractual relationship between two or more partners in a value chain. The contractual relationship is manifested by one or more contracts established between the partners. The target of the relationship is to provide a set of goods or services to one or more customers. The contracts are linked together through one or more common identifiers. The common identifiers include partner identities, good or service identifiers, identifiers of related or dependent goods or services, or other item common in a given value chain. Two examples of hierarchical relationships include:

Order—a hierarchical contractual relationship that covers the same identifiers as specified by an order.

Contract—a hierarchical contractual relationship that covers the same identifiers as specified in a contract.

Hub—In describing network topologies, a hub topology consists of a backbone (main circuit) to which a number of outgoing lines can be attached (“dropped”), each providing one or more connection port for device to attach to. The hub is the central information processing system(s) that communicates with one or more partners over a network.

Information Processing System—is any computer or similar device such as a personal computer, mid-size computer, main-frame computer, PDA, cellular phone or any device capable of communicating with a network.

Member—a partner that has joined a specific community such as PartnerCommunity, Inc. (see online URL www.partnercommunity.com for more information).

Multilateral—an environment where one or more partner or member participates in the Value Chain.

Network—a wired, wireless or broadcast connection between two or more partners that includes the Internet, Intranets, WANs, POTS, cellular, satellite and other communication networks.

Partner—is an entity in a value chain of goods and services that is either a provider or consumer. A partner may be an individual, company or another entity such as a government that contracts for goods and services.

Rules—one or more conditions to apply to a given set of facts to determine a procedure to be followed. The rules can be used in an inference based engine with IF THEN constructs. A set of rules usually work on a top-down principle in which the first rule in the list is acted upon first, so that conditions allowed by the first rule, will never be judged by the remainder of the rules. Rule bases typically have the format of SOURCE/DESTINATION/SERVICE/ACTION.

Service—any item including a good, service, money or the movement thereof, that a Subscriber may use. One class of Service is communication services, such as POTs (Plain Old Telephone Service) line, cable line, cellular line, satellite, T1 or TCP/IP connection or equivalent. Another class of Service is utilities such as gas, oil, electric, water, sewer purchased by a Subscriber. Still, another class of Service is transportation such as ticketing, tolls, freight charges, and shipping charges.

Service Level Agreement (SLA)—is a type of contract between a network service provider and a customer that specifies, usually in measurable terms, what services the network service provider will furnish. Many Internet service providers (Internet service provider) provide their customers with an SLA. More recently, IS departments in major enterprises have adopted the idea of writing a Service Level Agreement so that services for their customers (users in other departments within the enterprise) can be measured, justified, and perhaps compared with those of outsourcing network providers. Some metric that SLAs may specify include:

What percentage of the time services will be available;

The number of users that can be served simultaneously;

Specific performance benchmark to which actual performance will be periodically compared;

The schedule for notification in advance of network changes that may affect users;

Help desk response time for various classes of problems;

Dial-in access availability; and

Usage statistics that will be provided;

Value Chain—is an alliance of product and service providers coming together to provide a complete offering to a given set of customers.

Overview of Managing and Correlating Orders and Contracts

In this embodiment, the present invention provides an integrated system to automatically and continuously manage orders and contracts among trading partners The system tracks orders against contracts then, notifies and or reminds the trading partners of critical events and activities, including important dates, compliance and violations of the contractual terms. The present invention also allows trading partners, in a mutlilateral value chain, to define and add their rules for automatically generating notification, reminders, and triggering actions depending on the events. For example, a contract between two service providers may include a provision that one party commits to purchase 20,000 email boxes from the other party in the year 2000. In this case, an order would be an actual purchase of, for example, 25 email boxes. An example rule is to notify the providing partner if the quantity of orders does not increase linearly with time at a rate that allows ordering the 20,000 email boxes over one year.

The system uses a hub and spoke architecture where all contract information between trading partners is stored at the hub and all orders between the trading partners go through the same hub. The system consists of: (1) a user interface that allows one trading partner to enter-orders to be sent to other trading partners, (2) a programmatic interface that allows one trading partner to enter orders to be sent to other trading partners; (3) a user interface that allows trading partners to enter coordination rules; that is, conditions as related to orders and contracts and respective actions to be taken; (4) an analysis engine that tracks the orders and performs the analysis according to the provided rules; and (5) an action processor that performs actions as determined by the analysis engine.

Overview of Contract Management System

In this embodiment, the present invention provides a system and an architecture to: (1) automatically reconcile and coordinate related contracts in a value chain to ensure consistency among the contracts between the trading partners in the value chain, (2) automatically generate warnings and take actions for any inconsistencies, (3) streamline the contract generation process, and (4) enable service providers to automatically and programmatically negotiate service contracts.

Hub and Spoke Architecture

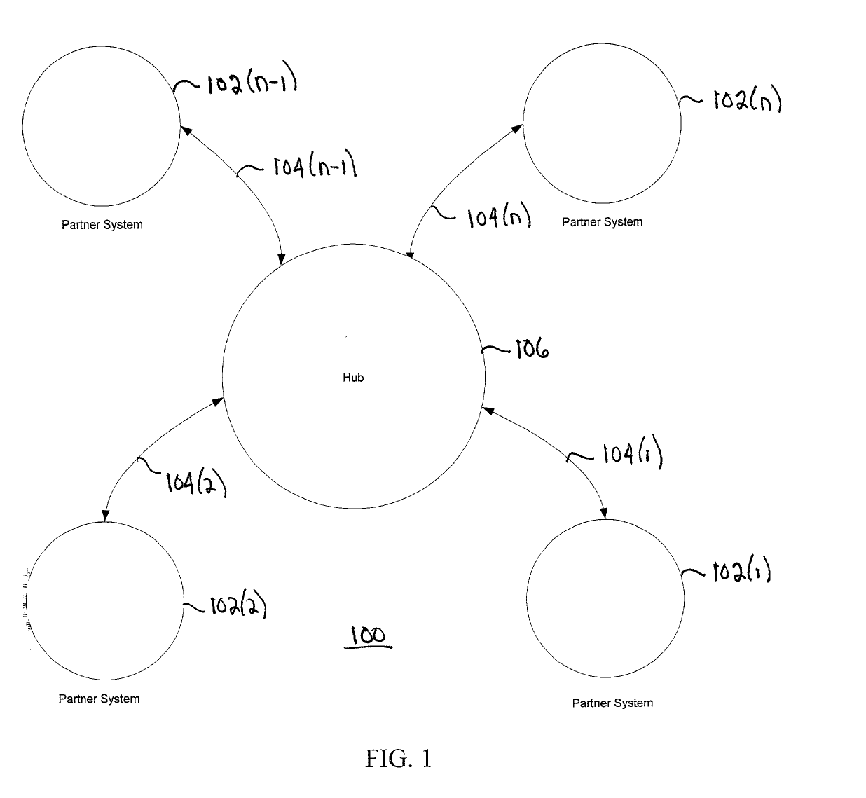

FIG. 1 is a high-level system 100 view of the hub and spoke architecture according to the present invention. The analogy of hub and spoke architecture comes from a wheel with a hub connecting to many spokes. In data communications, a hub is a place of convergence where data arrives from one or more directions and is forwarded out in one or more other directions. Here a hub 106 is the central information processing system that is connected over a network connection 104 (i.e., the spokes) to a partner system 102. Note there is a plurality of partner systems 102 (1, 2 . . . n-1, n) shown each connected via a network connection 104 (1, 2, . . . n-1, n) to the single hub 106.

Using the hub and spoke architecture 100 enables connectivity and therefore visibility to multi-dimensional and chained contracts the system 102 of each partner. In this architecture 100, partner systems 102 are connected to a central hub 106 where the contract management is provided as further described below. Connection to the hub 106 can use a multitude of communication protocols and could be achieved through different set of user interfaces. As describe in the section below, the hub 106 and partner system 102 can be produced in a variety of hardware and software combinations.

Discussion of Hardware and Software Implementation Options

The present invention, as would be known to one of ordinary skill in the art could be produced in hardware or software, or in a combination of hardware and software. The system, or method, according to the inventive principles as disclosed in connection with the preferred embodiment, may be produced in a single computer system having separate elements or means for performing the individual functions or steps described or claimed or one or more elements or means combining the performance of any of the functions or steps disclosed or claimed, or may be arranged in a distributed computer system, interconnected by any suitable means as would be known by one of ordinary skill in art.

According to the inventive principles as disclosed in connection with the preferred embodiment, the invention and the inventive principles are not limited to any particular kind of computer system but may be used with any general purpose computer, as would be known to one of ordinary skill in the art, arranged to perform the functions described and the method steps described. The operations of such a computer, as described above, may be according to a computer program contained on a medium for use in the operation or control of the computer, as would be known to one of ordinary skill in the art. The computer medium which may be used to hold or contain the computer program product, may be a fixture of the computer such as an embedded memory or may be on a transportable medium such as a disk, as would be known to one of ordinary skill in the art.

The invention is not limited to any particular computer program or logic or language, or instruction but may be practiced with any such suitable program, logic or language, or instructions as would be known to one of ordinary skill in the art. Without limiting the principles of the disclosed invention any such computing system can include, inter alia, at least a computer readable medium allowing a computer to read data, instructions, messages or message packets, and other computer readable information from the computer readable medium. The computer readable medium may include non-volatile memory, such as ROM, Flash memory, floppy disk, Disk drive memory, CD-ROM, and other permanent storage. Additionally, a computer readable medium may include, for example, volatile storage such as RAM, buffers, cache memory, and network circuits.

Furthermore, the computer readable medium may include computer readable information in a transitory state medium such as a network link and/or a network interface, including a wired network or a wireless network, that allow a computer to read such computer readable information.

Overall Data Flow for Tag Values Between Partners

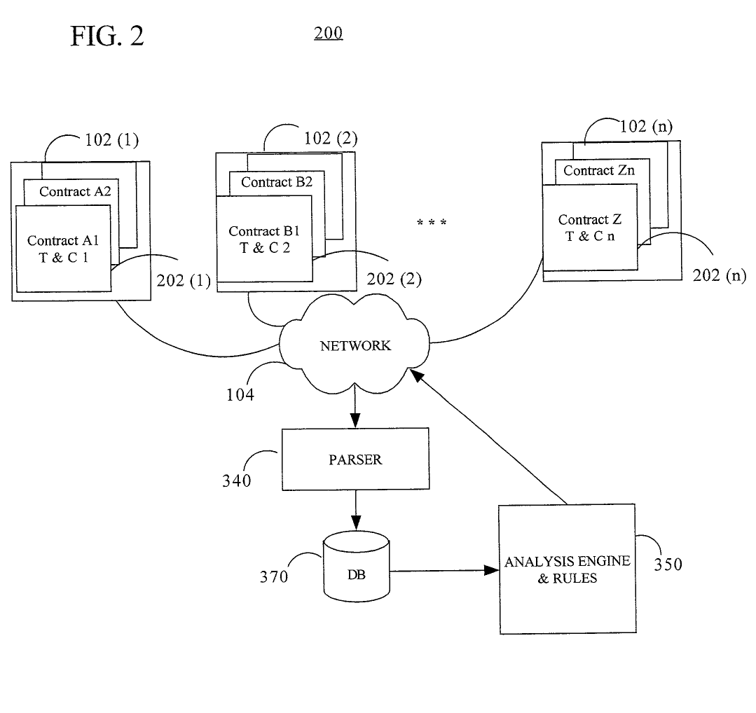

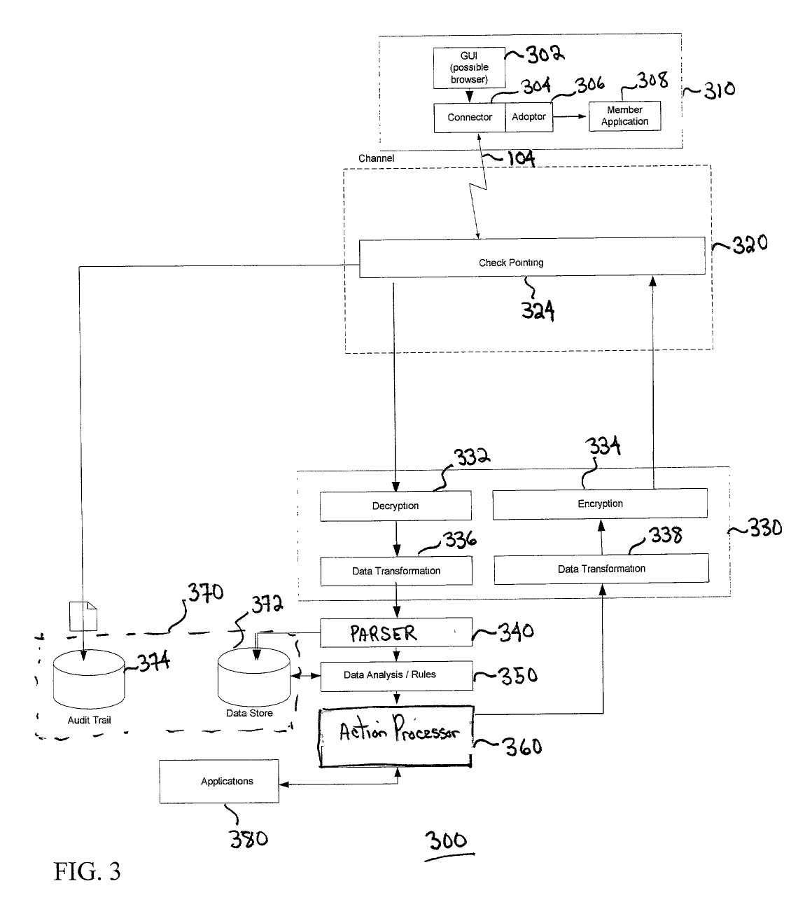

FIG. 2 is a block diagram 200 illustrating the overall data flow for tag values between partners using the hub and spoke architecture 300 of FIG. 3, according to the present invention. Each of the partner systems 102 (1, 2, . . . n-1, n) populates one or more documents 202 (1, 2, . . . n). Here the documents are contract templates built using DTD (data type definitions), XML schemas and/or XML documents. Each of these documents 202 (1, 2, . . . n) are sent over the network 104. A DTD parser, such as an XML parser retrieves the elements from each of the documents 202 and puts them into a database according to the XML tag values. The stored tag values are retrieved by the data and rules analysis engine 350 based on as predefined relationship such as by a partner identifier such as accountID. In order management embodiment, the orders belonging to the same accountID (e.g. partner) are retrieved. In the embodiment of contract negotiations all the contracts belonging to the same account are retrieved. Once the relevant stored tag values are retrieved from the database 370 depending on the embodiment, the data and rules analysis engine 350 are applied. And depending on the action from action processor 360 one or more of the partner systems 102 (1, 2, . . . n-1, n) are notified as required.

The partner systems 102 also enable through a interface 302 other input besides the contracts or orders such as individualized rules for the data and rules analysis engine 350 and actions to be performed by action processor 360.

Functional Block Diagram of Hub and Spoke Architecture

FIG. 3 is a functional block diagram 300 of the major system components using the hub and spoke architecture of FIG. 1, according to the present invention. The system 300 includes two basic components; a client component and hub (or server) component. Each of the two components is further divided into other subcomponents. The client component or client connector 310 is an application that resides on each of the partner's systems 102 and the second component is an application running on the hub 106 that connects all the partners systems 102. The client connector 310 residing on the partner's site includes a user interface 302 and/or a programmatic interface that allows partners to enter their orders. In one embodiment, the user interface 302 is a web browser. In another embodiment the interface 302 is a traditional order entry product where partners keep their individual view of the orders. The client connector 310 includes a connector 304 and adopter 306. The connector performs the task of communication, encryption and/or data transformation, sending orders and receiving acknowledgement, to the hub 106. The adopter 306 provides communication with member application 310. This allows members to continue operations, as before, using their back office applications for tracking their internal processes however, now with the additional benefit of multilateral functions provided by the Hub.

In another embodiment, the user interface 302 allows partners to enter their own rules for handling discrepancies between their orders and contracts as is further described in the section contract management below.

The hub 106 consists of six major components: channel 320; data transformation 330; parser 340; the data and rules analyzer 350; action processor 360 and databases 370. The overall process flow at the hub 106 is as follows:

Client Connector 310—The client connector 310 communicates with the Channel 320. The client connector provides user using partner systems 102 with a set of contract templates. Users fill-in these templates and insert controls, using interface 302, that is used during the other partner's modifications. This component is installed on each partner systems 102 (1, 2, . . . , n-1, n) and communicates the contracts to the hub 106 over network connection 104 (1, . . . , n-1, n). Communication with the hub 106 can be a web-based or programmatic message-based communication. For the web-based communication the connector 310 uses web browser infrastructure technologies such as Netscape Communicator™ or Microsoft Explorer™. In one embodiment, browser-based products like Pureedge™ are used to provide forms and support for digital signatures for the full or part of the form. For the message-based communication the channel 320 uses B2B integration servers like Microsoft BizTalk™ Server, Extricity Alliance™ server or other messaging products. In another embodiment, the user interface running on the partner systems 102 is a GUI that is specifically developed for this purpose, or through a programmatic connection to existing contract management systems. Example contract management systems that serve this purpose is ConTrack™ from Indigo Solutions™.

Channel 320—provides the protocol translation between the two negotiating partner systems 102 (1, 2, . . . , n-1, n) . It will also serve as a checkpoint for audit trail purposes. In order to provide this functionality different technologies can be used to support web-based and message-based communication. Examples of web-based communication web and application server's technologies that support the communication include Microsoft® IIS, Apache web server and/or BEA Weblogic™ server. Examples of programmatic message-based technologies are products like BizTaIk™ Orchestration or Extricity Alliance™. The channel 320 provides a checkpoint 324 via an audit trail stored in audit database 374.

Data Transformation 330—this component provides the data transformation 336, 338 between the two partner systems 102 (1, 2, . . . , n-1, n). As mentioned for the channel 320 products like BizTalk Orchestration or Extricity Alliance™ server can support both protocol translation and data transformation and has been found to produce desirable results. Before performing the data transformation it may be necessary to decrypt the message. Encryption 334 and decryption 332 use standard technologies. Different algorithms exist for encryption technologies. In one embodiment, the use of Public Key Infrastructure (PKI) provides acceptable results.

Parser 340—extracts the data elements from the received documents and stores those elements in the database 372. XML is used as an efficient method for building contract templates. Recently the World Wide Web Consortium (W3C) adopted the Extensible Markup Language (XML) as a universal format for structured documents and data on the Web. The base specifications are XML 1.0, W3C Recommendation February 1998. (See online URL www.w3.org for more information. The system 300 by being based on XML along with (Extensible Stylesheet Language) XSL enforces separation of content and presentation, thus allowing flexible rendering of the content to multiple device types. Similarly, the use of XML enables maximal reuse of information and data through the composition of XML fragments. One parsing tool which produces desirable results is Xerces (refer to online URL xml.apache.org for more information.) The parser 340 is used to extract data elements from contracts or other forms and store them in databases like Oracle™ or MS SQL server™. The results of the data transformation function are passed to the parser 340, which extracts the data elements and stores those elements in the database 372.

Data and Rules Analysis Engine 350—correlates the orders and contracts between partners. The correlation uses a relational database 372 that links orders with accounts and contracts. The data and rules analysis engine 350 determines all other contracts that are owned or related to the contract under negotiation based on the entity relationship; and based on captured rules and associations between those contracts a set of processing actions are taken. In one embodiment this component is rule or constrained based inference engines. Exemplary products that produce desirable results are ILOG rules from ILOG™ or Blaze Advisor™ from Blaze software.

Action Processor 360™processing actions that are required to support the decisions made by the analysis engine. Example actions are sending email, sending messages to connectors, forwarding contract to addressed party and much more.

Proprietary software components are developed to receive the action type, determine the respective application 380 to carry out the action then, call this application. Based on the required action the application could be as simple as an e-mail server or as sophisticated as messaging software.

Orders and Correlating Contracts at the Hub

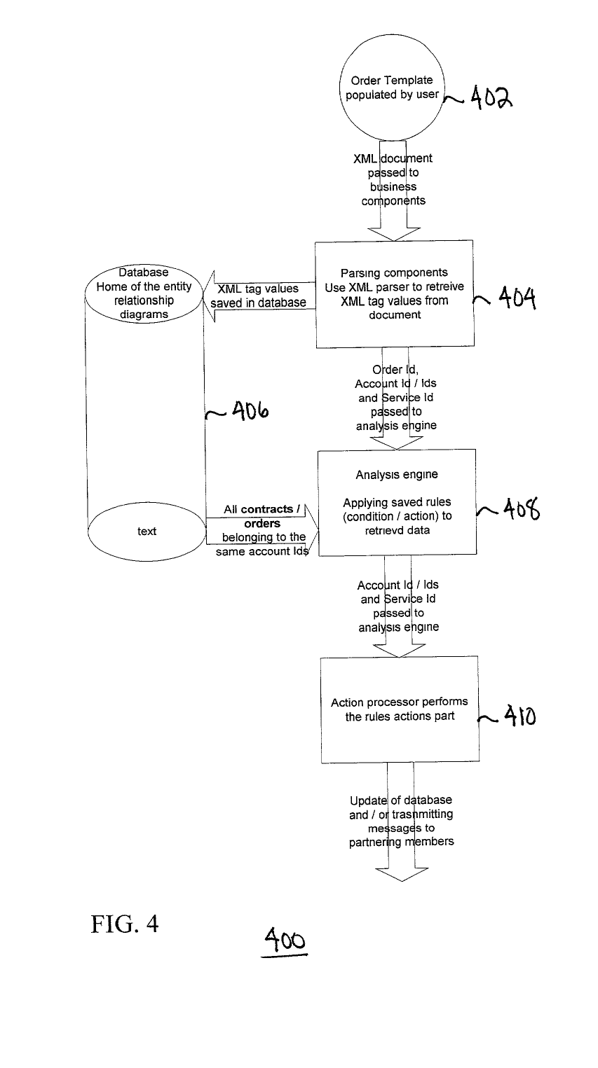

FIG. 4 is flow diagram 400 of the order reconciliation according to the present invention. Using the user interface 302 on partner system 202, the order template based on XML is populated by the user, step 402. The order template is passed over network 104 to hub 106 for processing. The parser 340 extracts the order data from the order template, step 404. The order data includes order attributes, order action class (e.g. activation, open order), identification numbers of ordering party, order line items (services covered in the contract), and other attributes.

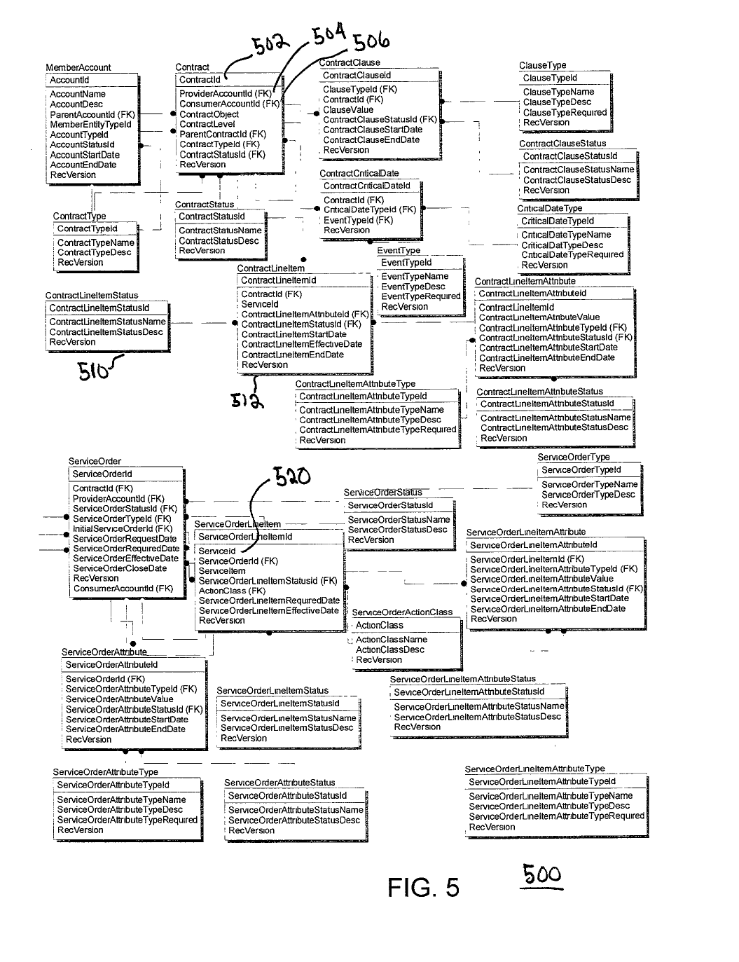

Using SQL the parser 340 saves the information retrieved from the XML order template into the database 370, step 406. The schema of the database is shown in FIG. 5 and discussed in further detail below.

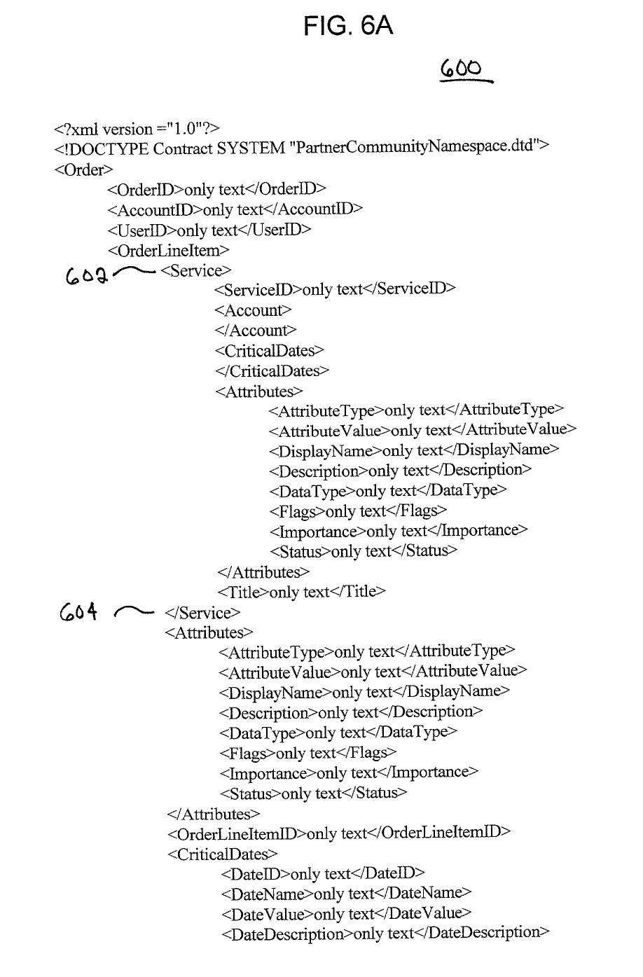

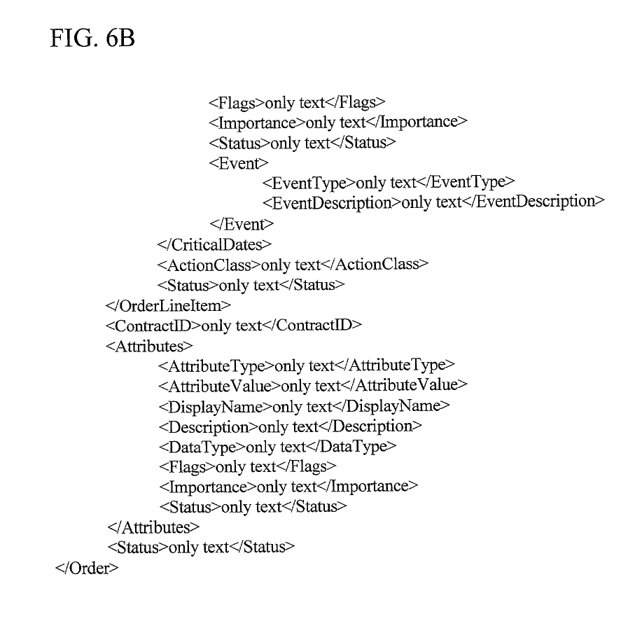

An identical naming convention is used in the XML document structure and the database 370 entity relationship diagram as shown in FIG. 6. Those of average skill in the art understand the map the data (tag values) from the XML document into table rows in the database. For example, the values of the XML tags Accountld and OrderLineltem under the tag Order in the XML document contain the values, mapped into the columns ProviderAccountId 530 in the service order table and OrderLineItemId 532 in the ServiceOrderLineItem table in the database. The same principle applies to the values of the other tags in the XML document.

In step 408, the parser components pass the OrderId 534, ProviderAccountId 530 and serviceIds 536 to the data and rules analysis 340. The tag naming in the XML document clearly identifies those Ids. Using the OrderId 534 the data and rules analysis engine 340 retrieves all the Orders and contracts related to the same service Id and belonging to the parties with the same account Id. It should be understood that the data and rules analysis engine 340 could also retrieve all Orders and contracts by other parties in that already established contracts with 530 . The data and rules analysis engine 340 applies rules that were previously configured by the contracting parties and passes the required actions to the action processor 350.

In step 410 the action processor performs the actions based on the request of the data and rule analysis engine 340. The action processor may use other applications for the completion of the required actions. An example application is an e-mail server like Microsoft Exchange. So, the action processor forms the messages and passes it to the e-mail server to send.

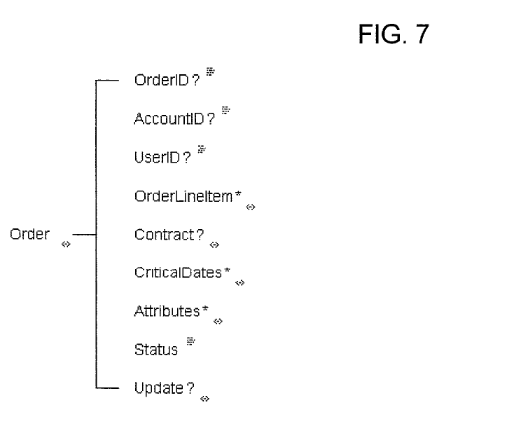

FIG. 5 is a schema 500 of an order entity relationship detailing the relationship between entities, according to the present invention. The schema 500 is saved in a relational database 372 such as Oracle™, Informix™, DB/2™, or SQL server™. The schema uses the notation of a dark circle one or both ends of a connecting line to denote a “one to many” relationship with the object connected by the black dot. For example the component “contractlinestatus” 510 has a “one to many relationship” with the component “contractlineitem 512. The schema details the relationships between members and objects. The schema shows the relation between orders, services being order and account information for the partner issuing the order. This same relation is also carried through the XML fragments as shown in FIG. 6 and FIG. 7. So, the parser can easily extract the data from the XML fragments and insert it into the database 372.

Returning to an example given above in the overview section of the e-mail boxes, assumes that a contract between two service providers, A and B, include a provision that one party commits to purchase 20,000 e-mail boxes from the other party in the year 2000. In this case, an order, from provider A, would be an actual purchase of, for example, 25 e-mail boxes.

The parser 340 extracts from the order the service identification, the quantity ordered, the action type of the order (example actions are reservation, activation), and the parties account numbers. Now, component data and rules analyzer engine 350 using data provided by parser 340 retrieves from the data store information in database 372 about all other orders for this service and the contracts having this service as a line item. Rules, saved in the rules analyzer, are applied to this data to help guide the business between the partnering providers. Providers use the interface 302 to enter rules into the system. Rules are saved as rule language files that are specific to the rule or constrained based inference engine being used. An example processing is:

If the sum of service order, from A, exceeds the contract quantity reject the order.

Another rule is:

If the sum of the service orders, from A, is within a certain percentage of the contract quantity process the order and send a notification back to ordering party.

Another rule is:

If the sum of the service orders is within a certain percentage of the contract quantity

AND

If the date of the order is within a certain window from the contract renewal date,

THEN

Process the order and initiate a contract negotiation process.

A more sophisticated and takes into consideration the contracts between provider B and his suppliers of services that support the ordered service. Such a potential rule is:

If the sum of service orders, from A, are within a certain percentage of the contract quantity

THEN

Send an order to provider C based on a separate contract between B and C.

Other rules include implications of the quantities ordered and the time period on pricing and potential discounts.

Turning now to FIGS. 6A and 6B are a template XML of the order tags used along with the order entity schema of FIG. 5, according to the present invention. The XML order 600 follows the rules of XML where each item starts with an opening tag 602 and a closing tag 604 where the convention is the closing tag 604 has the identical name preceding by a “/” in this example the opening tag 602 is “service” and the closing tag 604 is “/service”.

FIG. 7 is a tree diagram 700 of the XML order tags in FIG. 6 according to the present invention. The elements in the tree diagram are defined as follows:

OrderID 602—OrderID is the numerical unique identifier for the Order object instance.

AccountID 604—AccountID is account ID of the account that has the user making the order for the Order object instance.

UserID 606—UserID is the user that is making the order for the Order object instance.

Status 608—Status is one of a list of possible states associated with the Order object instance (New, Deleted, Changed, Invalid, Owner, . . . ).

OrderLineltem 610—OrderLineltem is the embedded OrderLineItem logical object associated with the Order object instance.

Contract 612—Contract is the embedded Contract logical object associated with the Order object instance.

CriticalDates 614—CriticalDates is the embedded CriticalDates logical object associated with the Order object instance.

Attributes 616—Attributes is the embedded Attributes logical object associated with the Order object instance.

Update 618—Update is an optional embedded logical object containing the XPath's for the elements that have been updated, inserted or deleted for this logical object.

Contract Negotiations at the Hub

The user of system 300 permits the automatic reconciliation of contracts in a value chain. A service provider is notified when the contract under negotiation contradicts with other downstream contracts that it has with other partners. For example, in the case where the service provider B is negotiating a contract with service provider A for providing certain services to service provider A and that service provider B needs certain services from service provider C in order to provide its services to A. In this case, the contract between B and C must be sufficiently comprehensive so that B can comply the terms and conditions in its contract with A. The system 300 knowing all the relevant upstream and down stream contracts, for both parties, and knowing all the business rules (as explained above) provides the intelligence to compare and reconcile those contracts and present to the negotiating members with the necessary actions that need to be taken.

For automatic reconciliation and coordination of a provider's own contracts, when a partner or member starts negotiation of a new contract, modify or terminate an existing contract, the present invention checks all related contracts, verifies and analyzes the effect and alerts the member about any potential conflict. During the setup of the system or at a later time the system allows the partner to input verification criteria and analyses rules which are used at contract negotiation time.

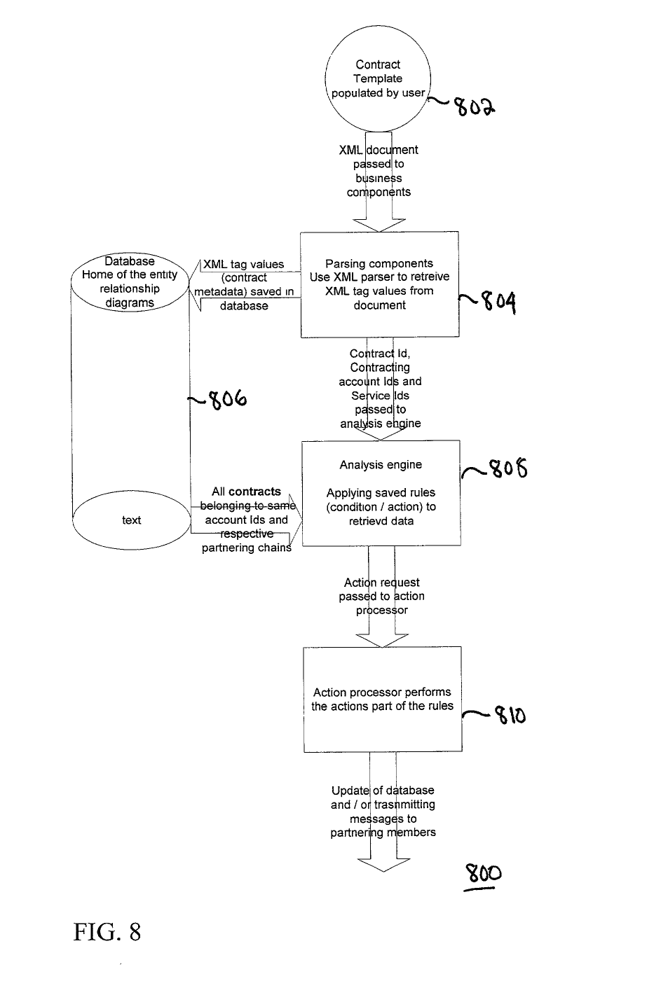

FIG. 8 is flow diagram 800 of the contract negotiations according to the present invention. Using the user interface 302 on partner system 202, the contract template based on XML is populated by the user, step 802. The order template is passed over network 104 to hub 106 for processing. The parser 340 extracts the contract metadata from the order template, step 804. The contract metadata includes contract clauses, contract critical dates, contract type, identification numbers of contracting parties, contract line items (services covered in the contract), and other attributes.

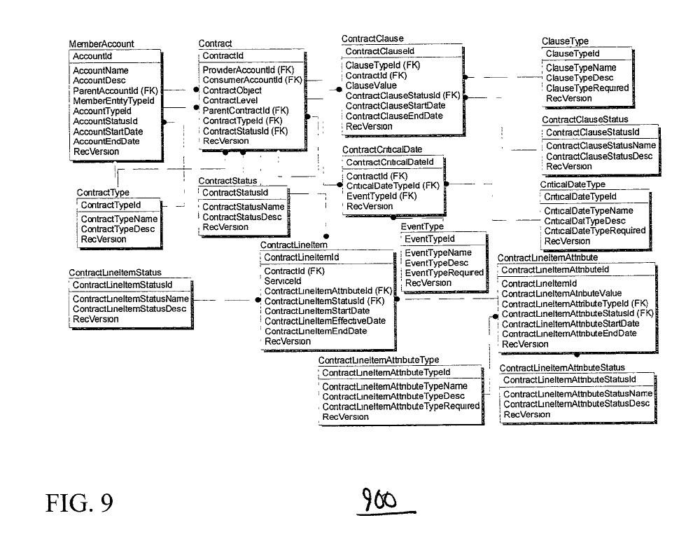

Using SQL the parser 340 saves the information retrieved from the XML contract template into the database 370, step 806. The schema of the database is shown in FIG. 9 and discussed in further detail below.

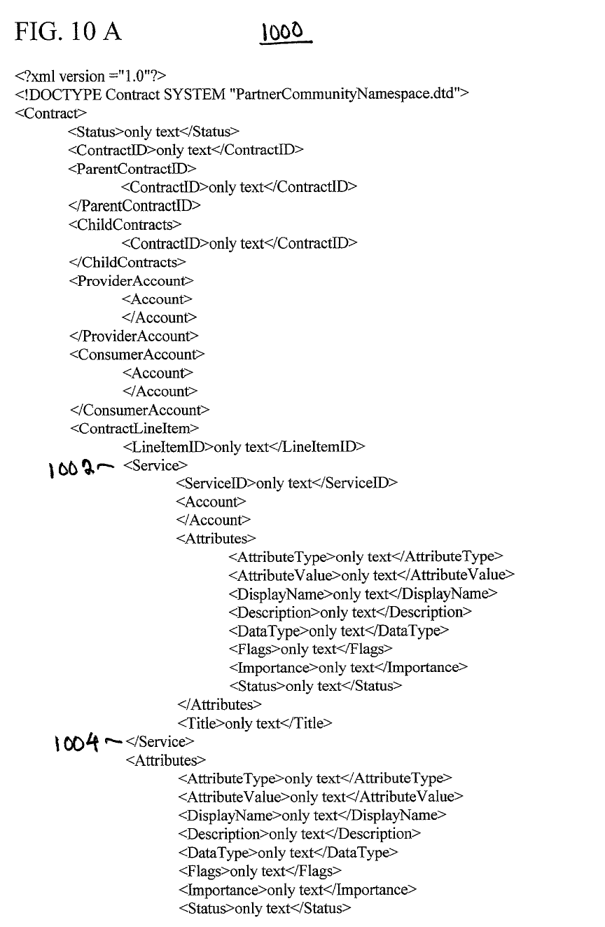

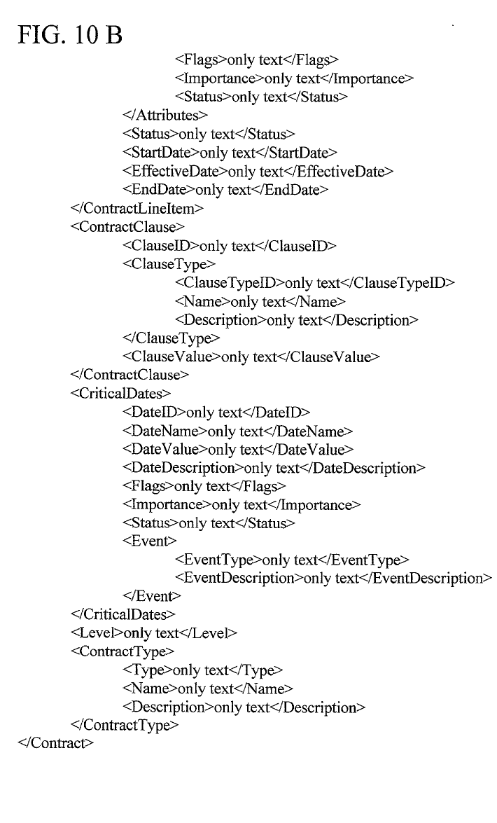

An identical naming convention is used in the XML document structure and the database 370 entity relationship diagram as shown in FIG. 10. Those of average skill in the art understand the map the data (tag values) from the XML document into table rows in the database. For example, the values of the XML tags ProviderAccountId 1004 and ConsumerAccountId 1006 under the tag Contract 1002 in the XML document contain the values, mapped into the columns ProviderAccountId and ConsumerAccountId in the Contract table in the database. The same principle applies to the values of the other tags in the XML document.

The parser components pass the ContractId 1002, contracting parties Ids (1004 and 1006) and serviceIds 1020 to the data and rules analysis 340. The tag naming in the XML document clearly identifies those Ids. Using the contracting parties Ids (1004 and 1006) the data and rules analysis engine 340 retrieves all the contracts related to the same service Id and belonging to the parties with the same account Id, step 808. It should be understood that the data and rules analysis engine 340 could also retrieve all contracts by other parties in that already established contracts with 1004 and 1006. The data and rules analysis engine 340 applies rules that were previously configured by the contracting parties and passes the required actions to the action processor 350.

In step 810 the action processor performs the actions based on the request of the data and rule analysis engine 340. The action processor may use other applications for the completion of the required actions. An example application is an e-mail server like Microsoft Exchange. So, the action processor forms the messages and passes it to the e-mail server to send.

For streamlining the contract generation this invention enables members to use contract templates, fill it, address it, sign it and save it. Contract clauses are automatically generated through two procedures. First one is based on member preferences and association of clauses with template tags. Contract templates are saved in the database 372 at the system setup time. The contract schema, presented in FIG. 9, is used for saving the template contracts. The contract type in the contract schema indicate template. The second is based on system suggested clauses learned from member's past history. Suggestions or alternative clauses are those used by the negotiating partner in previous contracts. All clauses are saved in the database 372 as shown in the schema of FIG. 9.

For the contract negotiation of service contracts the action of save a contract triggers the negotiation process sending the contract to the addressed party. In the simplest scenario the addressed party adds or modifies clauses to the document and save it. The saving process presents the document to the originating party highlighting the changes. This process repeats until the two parties agree on the terms; in which case the final signed document will be saved for future monitoring and addendums and a set of configuration procedures (provisioning) takes place that allows the originating member to have access to items listed in the contract.

In another embodiment, the originator embeds controls into the original document. Those controls can act as decision points that will help facilitate the negotiation process. The controls are either carried as part of the document or sent separately. One control produces satisfactory results is scripts embedded in HTML pages. A popular such control is used to prevent users of web pages to go forward if certain fields are not populated. In our case, an example of embedded controls is to put limits on prices so that if the addressed party changes the price to be higher than the limit the control will notify the member that this price is not acceptable.

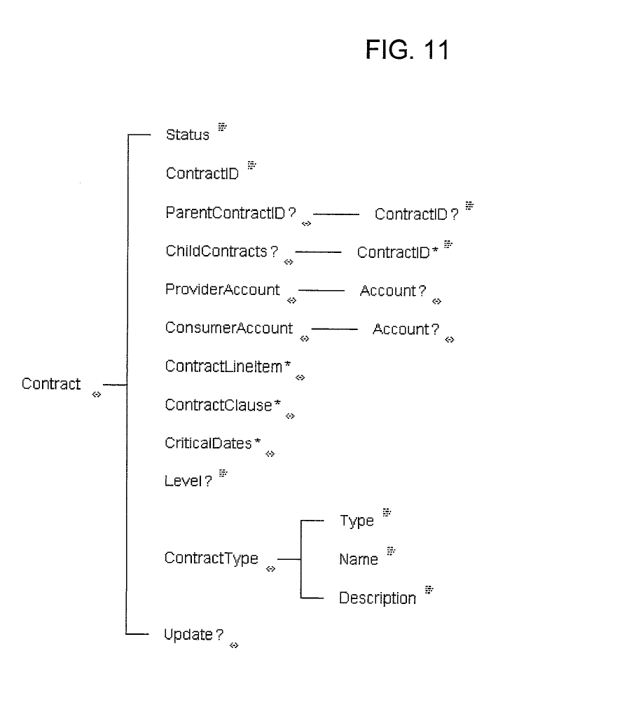

During contract negotiation the hub 106 processes contracts to automatically reconcile and coordinate related contracts in a value chain. In support of this processing a schema 900 is provided as shown in a template XML contract shown in FIG. 10 and the explanation of the tags given in FIG. 11.

The schema 900 in FIG. 9 is saved in a relational database such as Oracle™, Informix™, DB/2™, or SQL server™. Returning to the example above, where A is reselling a service purchased from C to B. In this example A, B, and C are parties in a value chain or partners in a value chain. As a further illustration, for simplicity, suppose that partner A (network service provider) is negotiating to outsource a front office application from partner B (application service provider). Partner A is requiring certain application availability and a certain throughput. Partner B is contracting with partner C (Hosting service provider) to provide hosting of partner B's applications. In this example, partner B is negotiating a contract with partner A for providing certain services to service partner A and that partner B needs certain services from partner C in order to provide its services to A. In this case, the contract between B and C must be sufficiently comprehensive so that B can comply the terms and conditions in its contract with A. In this exemplary explanation, it is assumed that partner A (network service provider) is negotiating to outsource a front office application from partner B (application service provider). Partner A is requiring certain application availability and a certain throughput. Partner B is contracting with partner C (Hosting service provider) to provide hosting of partner B's applications.

Sequence of Contracts Between Partners

1. Provider B (application service provider) negotiates a contract with provider C (hosting service provider) In this contract Provider C provides hosting of front office application for provider B. A complete copy of the contract will be saved at the hub 106. The hub 106 saves a set of metadata about the contract in database 372. Example metadata is availability metrics and measures.

2. After negotiating a contract provider B accesses the Hub through the interface 302 such as a GUI (graphical user interface) and associates rules with the negotiated contracts. Those rules are based on the metadata captured and are saved in the data transformation 330. Those rules will be applied later during the negotiation of the second contract in step 3 below.

3. Provider A (network service provider) negotiates a contract with provider B. During this negotiation the hub 106 references the contract metadata saved in step one above to guide, notify and alert the negotiating members of any inconsistency or risks in the terms being negotiated.

The flow of the contract negotiation in step three above is as follows:

a) Provider A starts with a contract template provided by the hub 106. This template can use different formats. Example formats are (1) formatted Microsoft Word document with headers specifying the contract clause titles, or (2) an XML document with tags used to specify the content of those tags. The XML format is the preferred format for this invention.

b) Provider A edits the contract clauses (the content of the named tags). A method of editing the contract clauses, using XML as the format, is an XSL style sheet. The style sheet presents the clauses as edit boxes that can be edited by the user. In one embodiment, a style sheet is used to keep track of the edit history in audit trail 374.

c) Provider A submits the contract to provider B through the Hub 106. In one embodiment, implementation of the submission action is an HTTP post or a message with the XML as the body with message formats using the Electronic Business XML (ebXML) initiative technical framework (see online URL www.ebxml.org for more information).

d) At the Hub 106 the message is first decrypted in data transformation 330. The parser 340 is used to retrieve the contents of specific XML tags . Those are the tags that describe the metadata of the contract. Then, SQL is used to insert this metadata into a database 370. The data and rules analyzer 350 using the contract identification of the contract under negotiation will retrieve related information from database 372.

e) The analysis engine applies the rules captured in step 2 of the contract sequence above. Then, calls processing action 360 for processing a specific action. An example rule is:

If service type is front office

Check all contracts containing line item hosting and line item attribute front office

If found

Compare line item hosting and line item attribute availability with availability under negotiation

If larger

Do action

If smaller

Do action

It will be understood to those of average skill in the art, that a rule related to throughput is typically more sophisticated; because the rule will take into account all partner B's outsourced contracts that are based on partner's C hosting contract.

Other rules include pricing advise partner B to the limits that partner B can negotiate and the effects of changing the rate.

“If service type is front office

Check all contracts containing line item hosting and line item attribute front office

If found

Compare line item hosting and line item attribute availability with

availability under negotiation

If larger

Do action

If smaller

Do action”

Turning now to FIGS. 10A and 10B are a template XML of the contract tags used along with the contract entity schema of FIG. 9, according to the present invention. The XML contract 1000 follows the rules of XML where each item starts with an opening tag 1002 and a closing tag 1004 where the convention is the closing tag 1004 has the identical name preceding by a “/” in this example the opening tag 1002 is “service” and the closing tag 1004 is “/service”.

FIG. 11 is a tree diagram 1100 of the XML contract tags in FIG. 10, according to the present invention. The elements in the tree diagram are defined as follows:

Status 1104—Status is one of a list of possible states associated with the ContractLineItem (New, Deleted, Changed, Invalid, Owner, . . . ).

ContractID 1106—is the numerical unique identifier for the Contract object instance.

ParentContractID/ContractID 1108—is the numerical value for the ContractID of the parent contract, if any, of the Contract object instance.

ChildContracts/ContractID 1110—contains a list of ContractID's which are the numerical values for the ContractID's of the child contracts, if any, of the this Contract object instance.

ProviderAccount/Account 1112—is the embedded Account logical object associated with the Provider account for this Contract object instance.

ConsumerAccount/Account 1114—is the embedded Account logical object associated with the Consumer account for this Contract object instance.

ContractLineItem 1116—is the optional and repeatable embedded ContractLineItem logical objects associated with the Contract object instance.

ContractClause 1118—is the optional and repeatable embedded ContractClause logical objects associated with the Contract object instance.

CriticalDates 1120—is the optional and repeatable embedded CriticalDates logical object associated with the Contract object instance.

Level 1122—is the numerical value based on 0 of the level from the top contract in the hierarchy of contracts to the Contract object instance.

ContractType 1124—is the embedded logical object containing the name, type and description of the type of contract associated with the Contract object instance.

ContractType/Type 1126—is the numerical unique identifier for the ContractType object instance.

ContractType/Name 1128—is the Contract Type name of the Contract object instance.

ContractType/Description 1130—is the Contract Type description of the Contract object instance.

Update 1132—Update is an optional embedded logical object containing the XPath's for the elements that have been updated, inserted or deleted for this logical object.

Non-Limiting Examples Shown

Although a specific embodiment of the invention has been disclosed. It will be understood by those having skill in the art that changes can be made to this specific embodiment without departing from the spirit and scope of the invention. The scope of the invention is not to be restricted, therefore, to the specific embodiment, and it is intended that the appended claims cover any and all such applications, modifications, and embodiments within the scope of the present invention.

What is claimed is:

1. A method for managing orders in a multilateral environment comprising:
receiving an order formed from an order template from the first system used by the first partner for ordering goods or services from a second partner;
determining if a first contract exists between the first partner and the second partner and if the first contract exists then:
parsing the order received into tag values representing predefined fields;
retrieving tag values for the contract, wherein the tag values contain terms that govern orders between the first partner and the second partner;
comparing the tag values for the order received against the tag values for the contract to determine compliance with the one or more contract terms and applying one or more rules for governing any discrepancies between the order and the first contract; and
notifying at least one of the first system used by the first partner and a second system used by the second partner if the tag value for the order received does not comply with the tag values for the contract terms ,and if the tag values for the order received does comply with the tag values for the contract, then placing the order with the second system used by the second partner.

2. The method according to claim 1, wherein the step of parsing includes parsing the order received into XML tag values representing predefined fields.

3. The method according to claim 1, further comprising the step of:
sending a user interface for presentation of an order template including user selectable predefined fields on a first system used by a first partner;

4. The method according to claim 3, further comprising:
prompting at least one of the first partner using the first system and the second partner using the second system for a set of rules to govern orders placed under the first contract.

5. The method according to claim 1, further comprising:
determining if the order placed for goods and services from the second partner contain any goods and services that are supplied by a third partner using a third system, and if any of the goods and services are provided by the third partner then:
comparing the tag values of the order received for goods and services supplied by the third party for compliance with a tag values for a second contract between the second partner and the third partner.

6. The method according to claim 5, wherein the step of comparing further comprises the sub-steps of:
retrieving one or more predefined rules between the second partner and the third partner; and
applying the rules retrieved for governing any discrepancies between the order and the second contract.

7. A business method for managing orders on a centralized hub processing unit in a hub and spoke architecture for a multilateral environment comprising:
linking a plurality of trading partners using partner systems over a network to a centralized hub processing unit;
receiving an order from a first partner using one of the plurality of partner systems for goods and services from a second partner using one of the plurality of partner systems;
parsing the order received into one or more tag values representing predefined fields;
querying the database for predetermined hierarchical contractual relationships between the plurality of trading partners based on the order received;
recursively analyzing the predetermined hierarchical contractual relationships between the plurality of trading partners by examining one or more contractual tag values stored in the database for contracts between each of the trading partners in the hierarchical contractual relationship to determine if the tag values for the order comply with the one or more contractual tag values in the hierarchical contractual relationship for any goods and services to be supplied by any trading partner that is a member of the hierarchical contractual relationship for the order.

8. The business method according to claim 7, wherein the step of parsing includes parsing the order received into one or more XML tag values.

9. The business method according to claim 7, wherein the step of recursively analyzing further comprises the sub-steps of:
retrieving one or more predefined rules from any trading partner that is a member of the hierarchical contractual relationship for the order; and
applying the rules retrieved for governing any discrepancies between the order and the trading partner in the hierarchical contract relationships supplying goods and services for the order.

10. The business method according to claim 7, further comprising the step of:
placing the requested tag values into a database with a database schema using a naming structure that is identical to the naming structure used for the requested tag values from the order received so that elements in the database schema can be populated directly from the requested tag values according to the predefined fields.

11. A business method for managing orders on a centralized hub processing unit in a hub and spoke architecture for a multilateral environment comprising:
linking a plurality of trading partners using partner systems over a network to a centralized hub processing unit;
presenting to at least one of the partner systems, a user interface for placing an order;
receiving an order from a first partner using one of the plurality of partner systems for goods and services from a second partner using one of the plurality of partner systems;
parsing the order received into one or more tag values representing predefined fields;
placing the tag values into a database with a database schema using a naming structure that is identical to the naming structure used for the tag values so that elements in the database schema can be populated directly from the tag values;
retrieving contract tag values that form a hierarchical contractual relationship between trading partners from a database for contracts between trading partners that supply any goods or services as determined by the tag values the order; and
analyzing the contract tag values that form a hierarchical contractual relationship for compliance with the tag values for the order and applying one or more rules for governing any discrepancies between the order and the contract tag values; and
sending an order to each of the trading partners if tag values for the order complies with the contract tag values that form the hierarchical contractual relationship.

12. The business method according to claim 11, wherein the step of parsing includes parsing the order received into one or more XML tag values.

13. The business method according to claim 12, wherein in the step of parsing includes parsing the order received into predefined fields consisting of a price, a quantity, a delivery date and other business terms.

14. A business method for managing orders on a centralized hub processing unit in a hub and spoke architecture for a multilateral environment comprising:
linking a plurality of trading partners using partner systems over a network to a centralized hub processing unit;
presenting to at least one of the partner systems, a user interface for placing an order receiving an order formed from an order template including user selectable predefined fields for ordering goods or services from a second partner;
receiving an order formed from the order template from a first partner using one of the plurality of partner systems for goods and services from a second partner using one of the plurality of partner systems;
parsing the order received into one or more tag values representing predefined fields;
placing the tag values into a database with a database schema using a naming structure that is identical to the naming structure used for the tag values so that elements in the database schema can be populated directly from the tag values;
retrieving contract tag values that form a hierarchical contractual relationship between trading partners from a database for contracts between trading partners that supply any goods or services as determined by the tag values the order; and
analyzing the contract tag values that form a hierarchical contractual relationship for compliance with the tag values for the order; and
sending an order to each of the trading partners if tag values for the order complies with the contract tag values that form the hierarchical contractual relationship.

15. The business method according to claim 14, wherein the step of parsing includes parsing the order received into one or more XML tag values.

16. The business method according to claim 15, wherein in the step of parsing includes parsing the order received into predefined fields consisting of a price, a quantity, a delivery date and other business terms.

17. A computer readable medium containing programming instructions for managing orders on a centralized hub processing unit in a hub and spoke architecture for a multilateral environment, the programming instructions comprising:
linking a plurality of trading partners using partner systems over a network to a centralized hub processing unit;
presenting to at least one of the partner systems, a user interface for placing an order;
receiving an order from a first partner using one of the plurality of partner systems for goods and services from a second partner using one of the plurality of partner systems;
parsing the order received into one or more tag values representing predefined fields;
placing the tag values into a database with a database schema using a naming structure that is identical to the naming structure used for the tag values so that elements in the database schema can be populated directly from the tag values;
retrieving contract tag values that form a hierarchical contractual relationship between trading partners from a database for contracts between trading partners that supply any goods or services as determined by the tag values the order; and
analyzing the contract tag values that form a hierarchical contractual relationship for compliance with the tag values for the order; and
sending an order to each of the trading partners if tag values for the order complies with the contract tag values that form the hierarchical contractual relationship.

18. The computer readable medium according to claim 17, wherein the programming instruction of parsing includes parsing the order received into one or more XML tag values.

19. The computer readable medium according to claim 18, wherein the programming instruction of parsing includes parsing the order received into predefined fields consisting of a price, a quantity, a delivery date and other business terms.

20. A centralized processing hub for managing orders in a multilateral environment, comprising:
a channel coupled to a network for providing protocol translation and bi-directional communication between a plurality of partner systems, wherein at least one of the plurality of partner systems is configured to receive at least one order from a first partner;
a parser coupled to the channel which parses an order received from one of the plurality of partner systems into one or more tag values representing predefined fields;
a database with a schema using a naming structure that is identical to the naming structure used for the tag values so that elements in the database schema can be populated directly from the tag values;
a data and rules analysis engine which checks the compliance of the order and contracts between partners by retrieving contract tag values that form a hierarchical contractual relationship between trading partners from the database for contracts between trading partners that supply any goods or services as determined by the tag values the order; and
an action processor which sends an order to each of the trading partners if tag values for the order complies with the contract tag values that form the hierarchical contractual relationship.

21. The centralized processing hub according to claim 20, wherein the data and rules analysis engine is a constraint based inference engine.

22. The centralized processing hub according to claim 20, wherein the data and rules analysis engine is a compatible with ILOG™ rules or Blade Advisor™.

23. The centralized processing hub according to claim 20, wherein the channel is a BizTalk orchestration™. or Extricity Alliance™. compatible product.

24. The centralized processing hub according to claim 20, wherein the parser parses the order to produce XML tag values.
